(19) United States
(12) Patent Application Publication
(10) Pub. No.: US 2021/0362427 A1
(43) Pub. Date: Nov. 25, 2021

(54) DETERMINING OBJECT MODEL TYPES

(71) Applicant: HEWLETT-PACKARD DEVELOPMENT COMPANY, L.P., Spring, TX (US)

(72) Inventors: Sergio Gonzalez Martin, Sant Cugat del Valles (ES); Matthew A Shepherd, Vancouver, WA (US); Kyle Mannari, Vancouver, WA (US)

(21) Appl. No.: 16/605,348

(22) PCT Filed: Jun. 19, 2018
(86) PCT No.: PCT/US2018/038204

§ 371 Date: Oct. 15, 2019

(51) Int. Cl. B29C 64/393; G06T 17/20; G06F 30/10; B33Y 10/00; B33Y 50/02

(52) U.S. Cl. CPC B29C 64/393; G06T 17/20; G06F 2113/10; B33Y 10/00; B33Y 50/02; G06F 30/10

(57) ABSTRACT

In an example, a method includes receiving, at least one processor, object model data describing at least part of a three-dimensional object to be generated using additive manufacturing. A model type may be determined from the object model data by at least one processor. When the model type is a mesh model, a volumetric model describing at least part of the three-dimensional object in terms of a plurality of sub-volumes may be determined by at least one processor. When the model type is a volumetric model, the sub-volumes which represent a surface of the three-dimensional object may be determined by at least one processor.

### BACKGROUND

Additive manufacturing processes, or three-dimensional (3D) printing, are processes in which three-dimensional objects may be formed, for example, by the selective solidification of successive layers of a build material, The object to be formed may be described in a data model. Selective solidification may be achieved, for example, by thermal fusing, binding, or solidification through processes including sintering, extrusion, and irradiation. The quality, appearance, strength, and functionality of objects produced by such systems can vary depending on the type of additive manufacturing technology and techniques used.

### BRIEF DESCRIPTION OF DRAWINGS

Non-limiting examples will now be described with reference to the accompanying drawings, in which:

FIGS. 1 and 2 are examples of methods of processing data for use in additive manufacturing;

FIG. 3 is an example of a method of generating an object using additive manufacturing;

FIGS. 4 and 5 are examples of apparatus for additive manufacturing processes; and

FIG. 6 is an example of a machine-readable medium in association with a processor.

### DETAILED DESCRIPTION

Additive manufacturing (or 3D printing) techniques may generate a three-dimensional object through the solidification of a build material. In some examples, the build material may be a powder-like granular material, which may for example be a plastic, ceramic or metal powder. The properties of generated objects may depend on the type of build material and the type of solidification mechanism used. Build material may be deposited, for example on a print bed, and processed layer by layer, for example within a fabrication chamber. According to one example, a suitable build material may be PA12 build material commercially referred to as V1R10A “HP PA12” available from HP Inc.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of at least one three-dimensional object to be generated (which may for example be generated from structural design data). The fusing agent may have a composition which absorbs energy such that, when energy (for example, heat) is applied to the layer, the build material coalesces and solidifies to form a layer of the three-dimensional object in accordance with the pattern. In other examples, coalescence may be achieved in some other manner. For example, a binder agent (e.g. a thermally curable binder agent or a UV curable binder agent) may be applied to build material.

According to one example, a suitable fusing agent may be an ink-type formulation comprising carbon black, such as, for example, the fusing agent formulation commercially referred to as V1Q60Q “HP fusing agent” available from HP Inc. In one example such a fusing agent may comprise any or any combination of an infra-red light absorber, a near infra-red light absorber, a visible light absorber, and a UV light absorber. Examples of print agents comprising visible light absorption enhancers are dye based colored ink and pigment based colored ink, such as inks commercially referred to as CE039A and CE042A available from HP Inc.

In addition to a fusing agent, in some examples, a print agent may comprise a detailing agent, which acts to modify the effects of a fusing agent or energy applied for example by inhibiting, reducing or increasing coalescence or to assist in producing a particular finish or appearance to an object. A property modification agent, for example comprising a dye, colorant, a conductive agent, an agent to provide transparency or elasticity or the like, may in some examples be used as a fusing agent or a modifying agent, and/or as a print agent to provide a particular property for the object. According to one example, a suitable detailing agent may be a formulation commercially referred to as V1Q61A “HP detailing agent” available from HP Inc. In some examples, the detailing agent is an aqueous composition (comprising a high percentage of water) which undergoes evaporation when heated, resulting in a cooling effect. In other examples, a cooling effect may be provided in some other manner.

Additive manufacturing systems (also referred to as three-dimensional, or 3D, printers) may generate objects based on structural design data. This may involve a designer generating a three-dimensional model of at least one object to be generated, for example using a computer aided design (CAD) application. The model may define the solid portions of the object(s). To generate three-dimensional object(s) from the model using an additive manufacturing system, the model data may be provided as, or may be processed to generate, slices of parallel planes of the model. Each slice may define a portion of a respective layer of build material that is to be solidified or caused to coalesce by the additive manufacturing system,

It has been proposed that object models may be provided as mesh models. A mesh model represents an object as a plurality of polygons. For example, the mesh model may represent at least the surface(s) of the object as a plurality of polygons. The polygons may be of a common type, for example comprising triangles. The object model data may for example be generated by a computer aided design (CAD) application. In one example, a mesh model may be specified in terms of the vertices of the polygons (by which edges joining the vertices and polygons enclosed by the edges may be defined).

In one example, a polygon mesh is a triangular mesh representing a surface of the object and each triangle in the mesh has three vertices each defined by their xyz coordinates v0, v1 and v2 (the location of the polygon vertices in 3D space). While the example of a triangle has been used here, the mesh may be based on a different polygon or polygons, which may in some examples be curved (rather than flat or planar) polygons. In some examples, a mesh model may be a manifold closed surface mesh. In some examples, the model may be provided as a ‘3MF’ format file. A 3MF file may contain one or a plurality of models (for example triangular meshes).

While mesh models are well suited to specifying surfaces, in particular the geometry thereof, they are less well suited to specifying object interiors.

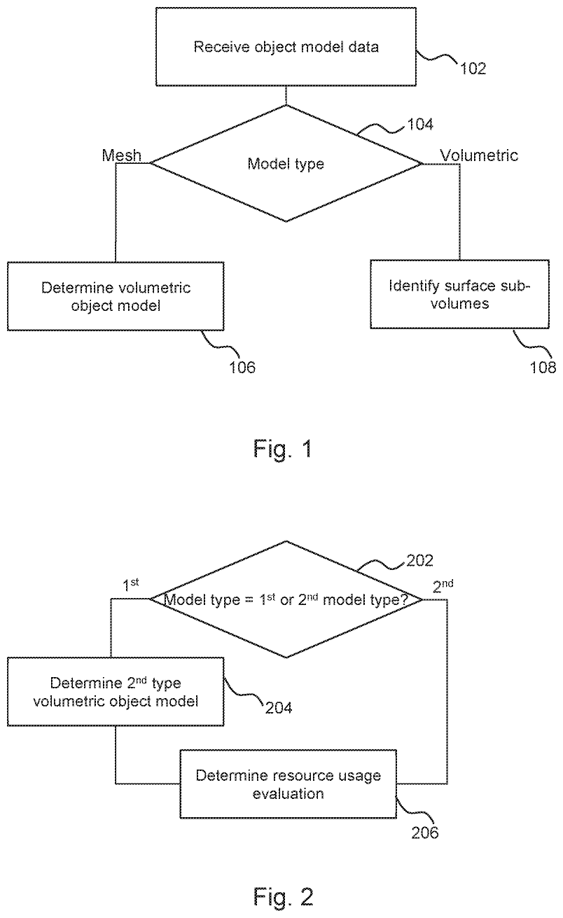

FIG. 1 shows an example of a method which may be a computer implemented method, for example carried out using at least one processor, and/or may comprise a method of processing data to be used in additive manufacturing.

Block 102 comprises receiving, at a processor, object model data describing at least part of a three-dimensional object to be generated using additive manufacturing and block 104 comprises determining, by at least one processor, a model type from the data content. In this example, this comprises determining if the model is a mesh model, for example a mesh model as described above, or a volumetric model which describes the object in terms of a plurality of sub-volumes (also referred to herein as voxels, as will be discussed below).

In some examples, mesh models may be models of object slices. For example, an object may be characterised as a ‘stack’ of mesh models of individual slices taken through the object. In some examples, each slice may correspond to a layer of the object to be generated in a layer by layer additive manufacturing process. Some examples of mesh models have been described above, but the method may also operate with other examples of mesh models, such as beam lattice models, displacement map models. Scalable Vector Graphics (SVG) models (which is a 2D vector image format) and other related model types.

A volumetric model, i.e. a model of the object as a plurality of sub-volumes (or ‘voxels’ as they may be termed herein by analogy with pixels), may for example comprise a file type such as a Shapeways SVX file type, or a modification thereof. In some examples, the files may be Portable Network Graphic (PNG) format files. In another example the file type may be some other suitable file type. In some examples, objects may be modelled as at least one ‘stack’ of ‘two-dimensional images’, each image representing a slice of the object model, and each corresponding to a layer to be manufactured in a layer by layer additive manufacturing process.

Two types of such volumetric models are discussed in particular herein. In a first type of volumetric model, a sub-volume based object model may be specified in terms of its properties (generally, a ‘property’ volumetric model herein). At its most simple, a voxel may be associated with the value of ‘present’ or ‘empty’. In other words, voxels may coincide with the object or not (noting that, for example, interior cavities do not comprise part of the object). In a more complex example, one or more appearance or functional property may be specified for a voxel. Thus, such a model may specify the intended color of a voxel as an RGB color value (or as a color value in some other color space such as LAB, CYMK, HSV, HSL, etc.). Other intended properties, such as density, strength, transparency, etc. may be expressed in a similar manner. For example, a density value in units such as gram/cm² may be specified. In another example, a strength in units such as pounds per square inch in a ‘test until failure’ test of a unit cube of the material may be specified. In another example, a transparency value may be specified as a mass attenuation/absorption coefficient, or the like.

In a second type of volumetric model, a sub-volume based object model may be specified in terms of print instructions (a ‘print-ready’ volumetric model herein), for example specifying print agents, print agent combinations, print agent amounts, and the like. In some examples, the print instructions may be specified in ‘dot space’, indicating precise locations for the placement of print agent dots. For example, in the case of color, a voxel may be associated with a set of print agents which produce an intended color, including in some examples the number of dots of the print agent within the voxel (which may be zero). For example print instructions may be specified in one or more ‘images’, where in some examples, each image may relate to the placement of a particular print agent. In an example, there may be n images of each slice, where n is the number of print agents to be applied. In some examples, each voxel (which is represented at a 2D pixel) in each image may be represented by a single bit indicating a binary choice: a print agent dot is to be applied to that pixel or not. However, in other examples, there may be more options, such as multiple drops, in which case there may be more than one bit per pixel. In some examples, print resolution pixels may be smaller than a voxel associated with a property, while in other examples they may be the same size (or larger). For example, a pixel may be specified at a resolution of 1200 dots per inch (dpi), which means it will have dimensions of around 20 microns in XY dimensions of the plane.

In practice, other volumetric model types may exist, and/or a particular model may contain aspects of each of the first and second type. For example, one property such as color may be specified in a print-ready format while another property such as strength may be specified as a property (for example in terms of an intended compressive strength value).

The determination of block 104 may be carried in a number, and/or in a combination, of different ways. In on example, the determination may comprise determining a file type based on a file extension, and/or parsing the data within the file in order to determine if the file is more likely to be a mesh model or a volumetric model (and if so, what type) based on the content thereof. In some examples, dedicated bytes within the file, and extracted in the parsing operation, may provide the file type. In some examples, a binary signature may be extracted and/or a manifest file supplied with the model (which may be in a compressed, for example zipped, format) may be inspected. In some examples, the data configuration itself may be compared to data models which are characteristic of the model type. Such methods may be used in combination, and/or other methods of determining the model type may be used in other examples.

In some examples, block 104 may further comprise selecting an appropriate computer language interpreter for the received file. For example, an ‘interpreter directive’ may be used to select an interpreter to parse and interpret the data content.

The method of FIG. 1 processes the model types differently depending on whether they are mesh models or volumetric models.

When it is determined in block 104 that the model type is a mesh model, the method proceeds to block 106 which comprises determining a volumetric model of the object, describing the object in terms of a plurality of sub-volumes. However, when it is determined in block 104 that the model type is a volumetric model of the object, the method proceeds to block 108 which comprises identifying the sub-volumes which represent a surface of the object.

To consider block 106 in greater detail first, this may comprise ‘voxelizing’ (i.e. 3D pixelating) the mesh model by associating properties with each of a plurality of voxels of predetermined geometry which coincide with the volume of the object model. In some examples, the voxels which fill and/or coincide with a surface of the object may be identified. In some examples, voxelization may comprise interpolation of property values specified for vertices of the mesh of the slice. For example, a first vertex may be associated with a first color value and a second vertex may be associated with a second color value. The color value along an edge joining the vertices may be determined as a weighted average of the first and second color values, wherein the weighting depends on the relative distance from each vertex. In other examples, interpolation of a property value for a 3D location between three or more vertices having defined property values may be carried out according to similar principles.

In some examples, voxelization may result in a property volumetric model, such that object properties may be specified at the voxel level. For example, a voxel at a given location may have at least one specified property: for example, it may have a particular color, transparency, conductivity, strength or the like.

In other examples, voxelization may result in a print ready volumetric model, for example by directly associating each vertex with print materials suitable for use, and interpolating in print agent space (rather than in property value space, as described above). In some examples, a property volumetric model may be generated first from a mesh model and transformed into a print ready volumetric model, for example through use of mapping (look-up) tables and/or algorithms which may associate object property values with print agents, print agent combinations and/or print agent amounts. In some examples, halftoning or the like may be carried out to determine where print agent drops are applied. In some examples, generating the print ready volumetric model may be carried out on a slice by slice basis.

Properties/print materials need not be specified for all voxels, and in some examples at least some voxels may be associated (for example in the absence of a specification of a property) with a default property, properties and/or print instructions.

As mentioned above, in generating control data for use in controlling an apparatus to generate the object, specified properties or combinations thereof may be mapped, via a look-up table, mapping algorithm or the like, to a print agent or print agent combination to apply to a physical location corresponding to the voxel of the object model. In some examples, the control data may also comprise specification of build material, processing times, temperatures and the like. In some examples, a halftoning process may be used to determine where print agent drops may be applied. As is discussed in greater detail below, this process of assigning print materials to voxels is relatively resource intensive and may be carried out on a slice by slice basis.

In some examples, prior to generating a volumetric model, a transformation may be applied to the mesh model. The transformation may comprise any or any combination of: a scaling transformation, a rotational transformation, a translational transformation, a symmetrical transformation, or the like. For example, an object may be defined in terms of its mesh vertices as set out above. These vertices may be specified relative to an origin and a translation may be used to place the virtual object at an intended location, orientation and scale in a virtual build volume.

Turning now to block 108, where a volumetric model has been input rather than a mesh model, the method comprises identifying the sub-volumes which represent a surface of the object. Determining the surface voxels allows the ‘shape’ of the object to be understood, which may be used in various data processing operations. For example, the shape may be used when combining a plurality of objects into a ‘batch’ with appropriately close packing. In another example, surface normals (i.e. vectors which are perpendicular to the object surfaces) may be determined, which in turn assists with property management. For example, knowledge of the surface normal (which, by convention, specifies the outwards direction, but could instead point ‘inwards’) assists in labelling voxels and subsurface voxels to associate them with properties such as color. For example, it may be intended that colored print agents are to be applied to surface and near surface voxels, but not to interior voxels as these will not be seen and this allows colored print agent resources to be conserved. However, in some examples, color is at least initially associated with surfaces or surface voxels, and not with the interior/interior voxels. This may not produce the intended visual effect, so the color property may be ‘propagated’ inwards to sub-surface voxels, for example to provide a shell thickness which provides an intended appearance. The shell thickness may be controlled by setting a distance to the surface which is evaluated for a particular point on an object model by reference to a defined normal. Object shapes and/or normals may also be used in other ways, for example in generating previews of an object or an object layer for display to a user. In some examples, such previews may also comprise property information such as color or the like.

Identifying the sub-volumes which represent a surface of the object in block 108 may comprise identifying the outer shell of an object. In some examples, the outer shell may be made up of voxels for which a colour property is specified (and may therefore be identified on this basis). In other examples, determining the surface voxels/sub-volumes may comprise inspecting a voxel to determine whether it has a full set of neighbours. If so, it may be determined that the voxel is an interior voxel. If however the voxel has less than a full set of occupied neighbour voxels, then this may be a surface voxel. In some examples, the model may be inspected on a slice by slice basis and a particular slice may be compared to the slice which is geometrically below and above the slice under inspection to determine whether a voxel has a full set of neighbours or not. Such a process may also be used in determining surface normals, by considering which neighbours are present.

In still other examples, identifying the sub-volumes which represent a surface of the object in block 108 may comprise accessing a tag identifying the surface voxels. In some examples, the shape of the object may be described in some other way, such as using a vector representation (for example an SVG representation).

In some examples, block 108 may be carried out conditionally on determination that the object model is a property volumetric model, and may not be carried out for print-ready volumetric models.

As briefly mentioned above, in some examples, it may be intended that a plurality of objects is to be generated in a single build volume/fabrication chamber. In some examples, data specifying a location of a model within a virtual model of a fabrication chamber or build volume may be provided and/or determined. This may be determined such that the objects each occupy a unique volume within the virtual build volume. In some examples, a rotation may be applied to an object model, for example to achieve a greater packing density of virtual objects within the virtual build volume.

In some examples, the at least one processor in block 102 may receive a full specification of the intended content of a virtual build volume, which may describe a plurality of objects having intended (and/or to be determined) relative locations. The data may be parsed so as to categorise the models as volumetric models or mesh models. The object models may differ in category. In some such examples, determining print ready volumetric models may be carried out on a slice by slice basis, wherein the slices correspond to layers of a fabrication chamber and each slice may contain part of more than one object (which may in some examples be based on more than one model type). In examples which include print ready volumetric models, this may comprise extraction of the data from the model for that portion of slice, whereas computation may be more intensive for other portions of the slice relating to different model types.

By designing a workflow which accepts more than one type of object model, and applying processing depending on the object model type, the versatility of the process may be improved.

The different model types may be suited to different intended use cases. For example, mesh models are widely used (and therefore accessible and well understood) and can have relatively small file sizes (in particular for relatively simple shapes and property specifications). Such models are relatively easy to manipulate, for example by scaling in one or more dimensions. However, some objects may be complex to define, either in terms of their geometry or in terms of their intended properties using a mesh model. In such cases, a sub-volume or voxel based representation may be more appropriate. For example, in some instances, a designer may intend to fully characterise the interior of an object. In such cases, mesh models become complex to define and increase in file size.

While volumetric object models tend to be larger in size than mesh models, these are well suited to providing a high degree of designer control of the output (even more so for print-ready volumetric models than for property volumetric models). In addition, the complexity of design need not always greatly affect the size of the model (although more complex models may have a higher level of entropy, which may in turn place limits on the lossless compressibility thereof and therefore compressed formats may differ in size). In some cases, such as those in which a designer seeks to have a high degree of control over the print output, the designer may specify print ready data describing the object. This allows greater control over the print instructions provided. In some examples, this may allow a designer to use techniques which go beyond the capabilities of a processor receiving data at a late stage in the design process. For example, a print apparatus (a ‘3D printer’) itself may comprise processing capabilities in order to generate print instructions. However, such apparatus may be relatively resource constrained and therefore the workflow itself may be relatively constrained. In addition, some workflow processes (in order to make efficient use of processing resources and memory) generate print control data during the printing process. In particular, one or more slices may be processed and used to generate/fabricate one or more layers whilst subsequent slices are being processed to generate control data for generating/fabricating the subsequent layers. Therefore, the inherent calculation complexity may be kept within bounds such that the time to process a slice to generate control data is not greater than (or not substantially greater than) the object layer generation time. However, where the processing may be carried out outside the ‘standard’ workflow by providing a print-ready volumetric object model, this is not a concern and complexity may be increased, in turn increasing the freedom of the designer.

Property volumetric models may be more versatile than print-ready volumetric models, in that they may be interpreted by more than one print apparatus type whereas a print ready model may generally be associated with the type of print apparatus on which 3D printing is to be carried out. In some examples, as set out in greater detail below, a print-ready volumetric model may be associated with a particular location within a fabrication chamber. In some examples, the file format itself of a print-ready volumetric model may differ based on print apparatus type. In some examples, for example due to different print apparatus capabilities, the placement of print materials to produce a particular print output may differ between print apparatus types or according to print apparatus settings, and therefore the file content of a print-ready volumetric models may be tailored for a particular apparatus type and/or parameters.

Thus while the same property volumetric model may be applicable to a variety of print apparatus types (and/or different locations within a fabrication chamber), the conversion of that property volumetric model to a print-ready volumetric model, and the resulting print-ready volumetric model, may differ depending on the apparatus which is to be used to generate the object represented by the model, and in some examples, the intended location of the object within a fabrication chamber. In some examples, a print apparatus intended to print the object according to a model may be encoded as a channel which has a Uniform Resource Identifier (URI) defining the type of content.

However, while print-ready volumetric models are generally highly tailored to a particular intended use, they allow a very high level of control over the print output. Therefore, they may be suitable in some use cases where a high level of control is appropriate.

The method of FIG. 1 allows different object model formats to be processed appropriately. For example, STL file types (or OBJ, PLY or Virtual Reality Modeling Language (VRML) files encoding mesh models) may be processed by the same workflow that accepts volumetric object models. By accepting a variety of model types, and tailoring a workflow accordingly, greater flexibility may be seen. Moreover, by allowing automatic classification of the object model type, the different model types may be seamlessly integrated.

FIG. 2 is an example of determining what type of volumetric model has been provided, and of processing the volumetric model.

Block 202 comprises determining if the model type is a first or second type of volumetric model. As outlined above, in the first type of volumetric model (property object models), sub-volumes are associated with intended object properties. In the second type of volumetric object model (print-ready object models), sub-volumes are associated with print materials. When it is determined in block 202 that a model type is the first type of volumetric model, the method further comprises (in addition to block 108 as described above), in block 204, determining the second type of volumetric model for the object. In other words, the first type of volumetric object model is processed to determine print materials to be associated with the sub-volumes/voxels. In some examples, this may be carried out on a slice by slice (layer by layer) basis (in some examples for layers which are intended to comprise part of more than one object)

Determining the second type of volumetric object model may comprise, for example, using one or more lookup tables to associate intended properties with print materials. In some examples, error diffusion and/or halftone techniques may be used to determine where to apply drops of print agent.

This is a relatively computing resource intensive operation. In general, specified properties may be extracted to generate a ‘bed layer’ image for every property containing the content from every part which is intersected by the layer Z being printed. In other words, there may be one image corresponding to each layer for each specified property. Predetermined transforms, which may be algorithmic and/or may refer to look-up tables, may be applied to the images to generate print-ready voxels. As well as the specified properties, other factors such as thermal management (e.g. applying enough fusing agent to result in fusion of an intended portion without also resulting in fusion of a neighboring portion of build material which is not intended to comprise part of the object) may be factored into the transforms applied. In some examples, techniques such as halftoning or error diffusion may be used to determine where print agents are placed. For example, the probability that a print agent is applied to each voxel or set of voxels may be less than one, and a halftoning or error diffusion algorithm may be used to determine which of the voxels of the set receives a drop of print agent.

Block 206 may follow either block 204 or a determination, in block 202 that the model type is a second type of object model. Block 206 comprises determining a resource usage evaluation for the object based on the second type of volumetric object model. For example, this may allow a cost to be associated with the generation of an object. In another example, it may allow a material usage to be defined such that sufficient build material and/or print agent may be provided, depleted stocks may be replaced or ordered, or the like. By determining this information for a single object (for example, rather than a batch), account information may be improved.

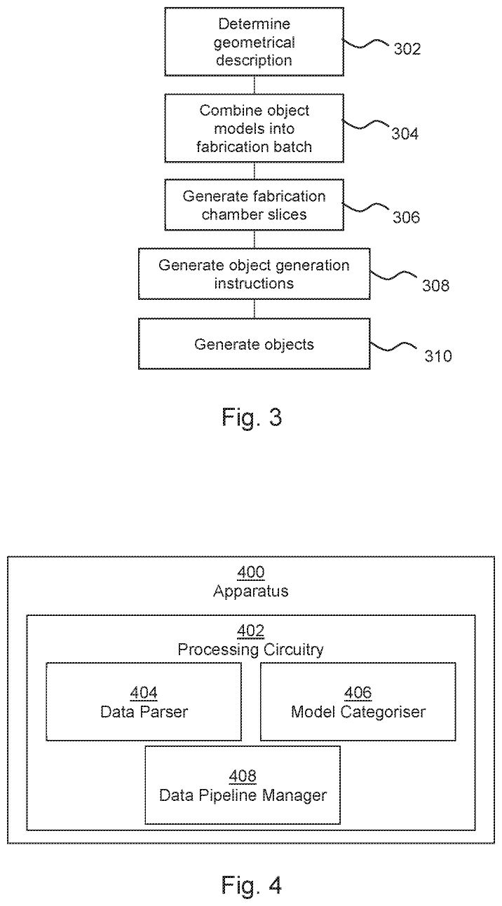

FIG. 3 is an example of a method of forming a batch for printing.

Block 302 comprises determining a geometrical description of the object. For example, this may comprise defining an object shape. While mesh models may be well-suited to determining the surface properties, in some examples, in order to determine the shape of a volumetric object model, the surface voxels may be identified as described above. A shape may be derived from the surface voxels. In other examples, the shape information can be received along with a volumetric object model. Determination of surface voxels may be carried out for volumetric models which are received as such and/or for volumetric models which are created for example according to the process of block 106 above.

Block 304 comprises combining object models of a plurality of objects using the geometrical description(s) (i.e. the shapes) to form a fabrication batch. This may comprise defining the relative locations of the objects, which may be defined by a set of volumetric object models at this point in the process. For example, this may comprise specifying an offset in X, Y and Z with respect to an origin (which may in practice be a lower corner of a virtual fabrication chamber), In some examples, placing the object may comprise applying a translation transformation matrix and/or a rotational transformation matrix. In some examples, at least one object model may have a position which is predetermined. As discussed in greater detail below, where a print-ready volumetric model has a predetermined position in a fabrication chamber, this allows the design process to include a consideration of the absolute position, and the halftone images generated may be generated so as to be printed in these specific positions.

This may reflect an intended print outcome. For example, the print instructions may differ depending on where in a fabrication an object is to be generated. Objects generated towards the boundary of the fabrication may be subject to different thermal conditions (for example, increased thermal gradients as heat is exchanged—usually lost—to the environment around the apparatus). Such effects may be countered by tailoring print instructions to the location of the object. Other hardware features, such as the travel of printheads and the like, which may otherwise result in variability in a generated output, may also be countered by tailoring print instructions to a location.

Other objects models may be placed around any fixed location object models (which may for example comprise print-ready volumetric models).

While in some examples, any object models which was originally a mesh model may be converted to a volumetric model prior to being positioned at this point, in other cases there may be a mixture of mesh and volumetric model types which are positioned in this way. For example, before processing an object model by carrying out blocks 106 or 108 described above, a translation transformation matrix may be applied to position the content inside the printable area of a three-dimensional printer (a fabrication chamber/build volume), in some examples to provide a relatively dense packing while avoiding overlapping/merging of parts. In the case of a volumetric object model, this may comprise defining an offset in X, Y and Z with respect to an origin voxel 0. This process may be controlled automatically and/or with user input to place specific content at specific positions.

Block 306 comprises generating a plurality of slices of the object model. Each slice generated may correspond to a layer of the object to be generated in additive manufacturing. In other words, each layer of a layer by layer additive manufacturing process may be associated with a slice of the object model. In some examples, the slices may be slices of a fabrication chamber, and may therefore incorporate slices of more than one object. In examples in which the object models comprise one or more stacks of slices, this may comprise extracting a slice from the stack.

Block 308 comprises generating object generation instructions from the object model data. For example, this may comprise voxelizing mesh models and/or assigning, where not previously assigned, print materials including print agents to each voxel as described above. In some examples, the position, size, number and/or composition of drops within a voxel may also be defined. A mesh model may be converted to a print ready volumetric model via a property volumetric model or directly. In other examples, the instructions may comprise instructions to control a location and/or path of build material deposit apparatus, light beam or the like. Where a print-ready volumetric model is provided, the print agent specification may simply be extracted, for example as data which is loaded into a bed layer image including any other object model slice(s) for that virtual fabrication chamber slice to produce a composite image. Then, this (in some examples, composite) bed layer image may be sent to be printed. In some examples, there may be different bed layer images of a given layer which correspond to different print agents.

Block 310 comprises generating the batch of objects using the object generation instructions. For example, this may comprise providing a first layer of build material on a print bed, selectively applying a fusing agent and/or fusion modification agent thereto, providing energy for example in the form of heat and subsequently forming a second layer. The process may be repeated until all the intended objects within a fabrication chamber are generated in a layer by layer manner.

As noted above, blocks 308 and 310 may be carried out at least partially concurrently, with at least one layer to be fabricated earlier being generated while at least one slice representing a layer to be generated subsequently is being processed for example to determine at least one bed layer image modelling a slice of a virtual fabrication chamber.

In some examples, the methods of FIG. 1, 2 and/or 3 may be carried out using processing circuitry provided on an additive manufacturing apparatus/3D printer. This may allow for multiple file types to be smoothly integrated into an object generation pipeline.

FIG. 4 shows an example of apparatus 400 comprising processing circuitry 402. The processing circuitry 402 comprises a data parser 404, a model categoriser 406 and a data pipeline manager 408.

In use of the apparatus 400, the data parser 404 parses a data file comprising a model of an object to be generated in additive manufacturing. In some examples, it may extract data indicative of the type of model, such as a header or binary signature, data structure, a file manifest or the like. In some examples, the data parser 404 may select a language interpreter to process the file.

The model categoriser 406 categorises the type of model based on the data extracted by the data parser 404. The data pipeline manager 408 selects a data processing pipeline for the data file to generate object generation instructions based on the model category.

In some examples, the model categoriser 406 categorises the model as a mesh object model or as a voxel (i.e. volumetric) object model, as described above. In some examples, the model categoriser 406 categorises a voxel object model as an object property voxel model, in which at least one voxel is associated with an object property, or as a print material voxel model, in which at least one voxel is associated with print materials for generating the object. In other words, the model categoriser 406 categorises the object model as a property model or a print ready model, as described above.

The processing circuitry 402 may, for example, carry out any of the methods of FIGS. 1, 2 and/or 3 described above.

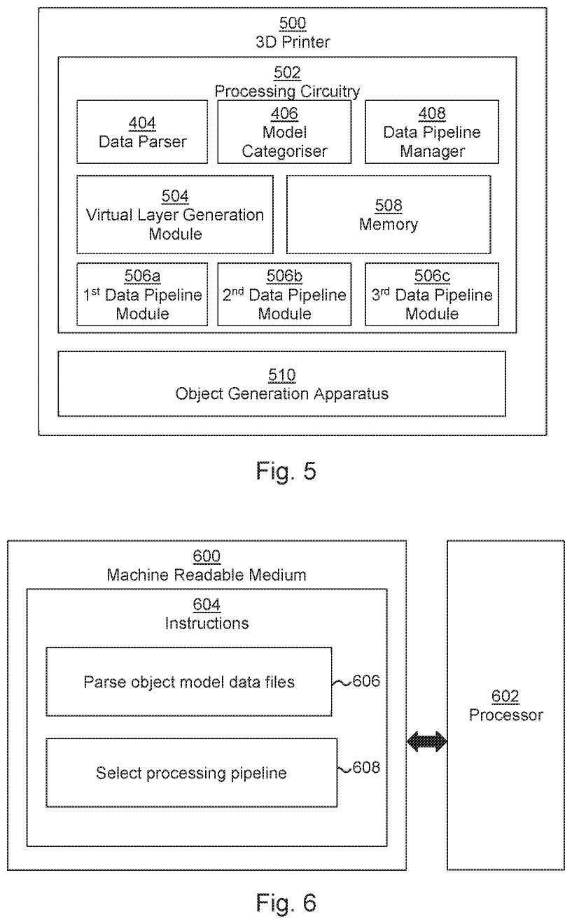

FIG. 5 shows an example of a three-dimensional (3D) printer 500 comprising processing circuitry 502, the processing circuitry 502 comprising the data parser 404, model categoriser 406 and data pipeline manager 408 as described in relation to FIG. 4.

In addition, the processing circuitry 502 of FIG. 5 comprises a virtual layer generation module 504, a first data pipeline module 506a, a second data pipeline module 506b, a third data pipeline module 506c and a memory 508. The 3D printer 500 further comprises object generation apparatus 510.

In use of the 3D printer 500, the virtual layer generation module 504 determines at least one ‘image’ representing a layer of an object generation chamber. In some examples, there may a number images. An image may provide a ‘map’ of the intended placement of an associated print agent(s), The virtual layer generation module 504 may employ different methods depending on the model type. For example, if the virtual layer comprises an object portion described by a mesh model, the virtual layer generation module 504 may ‘voxelize’ the layer. In some examples, the voxelization may be directly into a print ready format, whereas in other examples there may be a subsequent process to associate print instruction data with the voxels, as has been described above. If the virtual layer comprises an object portion described by an object property voxel model, the virtual layer generation module 504 may associate print instruction data with the voxels, as has been described above. If the virtual layer comprises an object portion described by a print material voxel model, the virtual layer generation module 504 may extract the print material data for inclusion in an image of the layer. Where a layer is to contain parts of objects described by more than one model type, the virtual layer generation module 504 may use a combination of these techniques.

In this example, the virtual layer generation module 504 utilises the first, second and third data pipeline modules 506a-c as appropriate. The first data pipeline module 506a generates a voxel object model from a mesh object model. The second data pipeline module 506b associates print material data with voxels. For example, properties associated with voxels may map, via a look-up table, algorithm or the like to a print agent or print agent combination to apply to a location corresponding to the voxel. In some examples, a halftoning process may be used to determine where print agent drops may be applied within that location. The third data pipeline module 506c determines the surface voxels of an object model. The virtual layer generation module 504 may use the output of the third data pipeline module 506c to generate previews of the layer, to determine surface normals, to propagate properties though a model (for example to associate a color with sub-surface voxels up to a depth), or the like. The first data pipeline module 506a may be applied when it is determined that the model type is a mesh model. The second data pipeline module 506b may be applied when it is determined that the model type is a volumetric property model. The third data pipeline module 506c may be applied when it is determined that the model type is a volumetric model of one or either type.

Data associated with an object to be generated in additive manufacturing is stored in an associated, dedicated, memory portion of the memory 508. Providing a dedicated memory space may improve the ease of accountability in object generation. The object generation apparatus 510 may be used to generate one or more objects described by the model(s) of one or more data file(s). The object generation apparatus 510 may generate objects in a layer-wise manner by selectively solidifying portions of layers of build material. The selective solidification may in some examples be achieved by selectively applying print agents, for example through use of ‘inkjet’ liquid distribution technologies, and applying energy, for example heat, to each layer. The object generation apparatus 510 may comprise additional components not shown herein, for example a fabrication chamber, a print bed, print head(s) for distributing print agents, a build material distribution system for providing layers of build material, energy sources such as heat lamps and the like, which are not described in detail herein.

In some examples, the apparatus 400 and/or 3D printer 500 may carry out at least one block of FIG. 1, 2 or 3.

FIG. 6 is an example of a tangible machine readable medium 600 in association with a processor 602. The machine readable medium 600 stores instructions 604 which may be non-transitory and which, when executed by the processor 602, cause the processor 602 to carry out processes. The instructions 604 comprise instructions 606 to parse object model data files to determine which of a plurality of predetermined data processing pipelines to select for the object model data in order to generate additive manufacturing instructions, and instructions 608 to apply a selected data processing pipeline to an object model data file; wherein the predetermined data processing pipelines comprise a voxel generation pipeline (i.e. a ‘voxelisation’ pipeline), a surface determination pipeline (for example to identify the voxels which are at the surface of the object); and a voxel level print material specification pipeline (for example to associate print materials with voxels).

In some examples, the instructions 604 may comprise instructions to cause the processor 602 to select and apply the voxel generation pipeline to mesh model data. In some examples, the instructions 604 may comprise instructions to cause the processor 602 to select and apply the surface determination pipeline to voxel model data and, if the voxel model data does not specify print materials at a voxel level. In some examples, the instructions 604 may comprise instructions to cause the processor 602 to select and apply the voxel level print material specification pipeline to voxel model data.

In some examples, the instructions 604 may comprise instructions to cause the processor 602 to carry out at least one block of FIG. 1, 2 or 3, and/or may provide at least one module of the processing circuitry 402, 502.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that various blocks in the flow charts and block diagrams, as well as combinations thereof, can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices (such as the data parser 404, model categoriser 406, data pipeline manager 408, virtual layer generation module 504, first data pipeline module 506a, second data pipeline module 506b, and/or third data pipeline module 506c) may be implemented by a processor executing machine readable instructions stored in a memory (which may be the memory 508 or a different memory resource), or a processor operating in accordance with instructions embedded in logic circuitry. The term ‘processor’ is to be interpreted broadly to include a CPU, processing unit. ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by blocks in the flow charts and/or the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
receiving, at least one processor, object model data describing at least part of a three-dimensional object to be generated using additive manufacturing;
determining, by at least one processor, a model type from the object model data;
when the model type is a mesh model, determining, by at least one processor, a volumetric model describing at least part of the three-dimensional object in terms of a plurality of sub-volumes; and
when the model type is a volumetric model, identifying, by at least one processor, the sub-volumes which represent a surface of the three-dimensional object.

2. A method according to claim 1 further comprising:
determining, by at least one processor, if the model type is a first type of volumetric model or a second type of volumetric model, wherein, in the first type of volumetric model, sub-volumes are associated with intended object properties and, in the second type of volumetric model, sub-volumes are associated with print materials; and
when the model type is the first type of volumetric model, determining, by at least one processor, a volumetric model of the second type.

3. A method according to claim 2 further comprising determining, by at least one processor, a resource usage evaluation for an object based on the second type of volumetric model.

4. A method according to claim 1 further comprising determining, by at least one processor, a geometrical description of the object and combining object models of a plurality of objects using the geometrical description to form a fabrication batch.

5. A method according to claim 1 further comprising generating, by at least one processor, object model data describing each of a plurality of slices of the object, each slice corresponding to a layer of the object to be generated in additive manufacturing.

6. A method according to claim 1 further comprising generating, by at least one processor, object generation instructions from the object model data and generating an object using the object generation instructions.

7. Apparatus comprising processing circuitry, the processing circuitry comprising:
a data parser, to parse a data file comprising a model of at least part of an object to be generated in additive manufacturing and to extract data indicative of a model type;
a model categoriser, to categorise the model type based on data extracted by the data parser; and
a data pipeline manager, to select a data processing pipeline for the data file to generate object generation instructions based on the model category.

8. Apparatus according to claim 7 wherein the model categoriser is to categorise the model as a mesh object model or as a voxel object model.

9. Apparatus according to claim 8 wherein the model categoriser is to categorise a voxel object model as an object property voxel model, in which at least one voxel is associated with an object property, or a print material voxel model, in which at least one voxel is associated with print materials for generating the object.

10. Apparatus according to claim 7 wherein the processing circuitry further comprises a virtual layer generation module which is to determine an image representing a layer of an object generation chamber.

11. Apparatus according to claim 7 comprising:
a first data pipeline module wherein the first data pipeline module is to generate a voxel object model from a mesh object model;
a second data pipeline module, which is to associate print material data with voxels; and
a third data pipeline module, which is to determine voxels representing a surface of a voxel object model.

12. Apparatus according to claim 7 further comprising a memory wherein data associated with an object to be generated in additive manufacturing is stored in an associated memory portion.

13. Apparatus according to claim 7, wherein the apparatus is a three-dimensional printer and further comprises object generation apparatus, wherein the object generation apparatus is to generate the object described by the model of the data file.

14. A tangible machine readable medium storing instructions which, when executed by a processor, cause the processor to:
parse object model data files to determine which of a plurality of predetermined data processing pipelines to select for the object model data files in order to generate additive manufacturing instructions;
apply a selected data processing pipeline to an object model data file;
wherein the predetermined data processing pipelines comprise a voxel generation pipeline, a surface determination pipeline and a voxel level print material specification pipeline.

15. The tangible machine readable medium according to claim 14 further storing instructions which, when executed by the processor, cause the processor
to select and apply the voxel generation pipeline to mesh model data; and
to select and apply the surface determination pipeline to voxel model data and, if the voxel model data does not specify print materials at a voxel level, to select and apply the voxel level print material specification pipeline to the voxel model data.
